(19) United States
(12) Patent Application Publication
(10) Pub. No.: US 2026/0350461 A1
(43) Pub. Date: Nov. 5, 2026

(54) MACHINE LEARNING WITH FEDERATED DATA IN GPUS AND DIRECT AI CORE DEPLOYMENT

(71) Applicant: SAP SE, Walldorf (DE)

(72) Inventors: Sangeetha Krishnamoorthy, Pleasanton, CA (US); John Seeburger, Brooklyn, NY (US); Karishma Kapur, Oceanside, CA (US); Ran Bian, Newark, CA (US); Alex Bishka, San Mateo, CA (US); Sivakumar Nagapandi, San Jose, CA (US)

(21) Appl. No.: 19/194,903

(22) Filed: Apr. 30, 2025

(51) Int. Cl. G06N 20/00; G06F 8/61; G06F 16/28

(52) U.S. Cl. CPC G06N 20/00; G06F 8/61; G06F 16/283

(57) ABSTRACT

Described is machine learning (ML) with federated data in graphics processing units (GPUs) and direct artificial intelligence (AI) core deployment. In a computer-implemented method, federated ML (FedML) library is installed in a ML platform. From a warehouse as a service solution, data is read from semantic models directly into a GPU dataframe library. A trained model is deployed into an artificial intelligence (AI) service.

### BACKGROUND

Traditionally, using data (e.g., from SAP of Walldorf, Germany) with a machine-learning (ML) platform or artificial intelligence (AI) service like GOOGLE VERTEX AI, MICROSOFT AZURE ML, AMAZON SAGEMAKER, or IBM WATSONX.AI on graphics processing unit (GPU) computes requires persisting the data on a ML platform first, e.g. in GOOGLE CLOUD STORAGE or DATABRICKS DELTA LAKE. However, this persistence requirement creates a data duplication problem that leads to data inconsistencies and loss of data governance. Moreover, duplicated data needs to be transformed and read into GPU-supported data structures before it can be used for model training. This creates multi-step, inefficient, and error-prone processes that increase an overall total cost of ownership (TCO) of ML projects.

### SUMMARY

The present disclosure describes machine learning with federated data in graphics processing units (GPUs) and direct artificial intelligence (AI) core deployment.

In an implementation, a computer-implemented method, comprises: installing a federated machine-learning (ML) (FedML) library in a ML platform; reading, from a warehouse as a service solution, data from semantic models directly into a graphics processing unit (GPU) dataframe library; and deploying a trained model into an artificial intelligence (AI) service.

The described subject matter can be implemented using a computer-implemented method; a non-transitory, computer-readable medium storing computer-readable instructions to perform the computer-implemented method; and/or a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. Prior to providing GPU support, federated machine learning (FedML) library architecture supported just central processing units (CPUs). For machine learning (ML) models built in GPU computes, data (e.g., business or other data) needed to be egressed out of SAP (i.e., SAP of Walldorf, Germany) systems (e.g., causing duplication and inconsistency issues) and then read back into GPUs. While the original architecture worked for simpler traditional models, it could not be used in GPUs as it did not support GPUs, nor could the ML models be deployed in SAP AI CORE functionality. With the described approach, not only can the SAP data be read directly into GPUs, but ML models trained on those GPUs can be seamlessly deployed into SAP AI CORE functionality directly from the GPU platform's ML environment. The approach simplifies complex ML model training and deployment on GPUs, bringing it closer to SAP systems and protecting SAP's data that was originally otherwise egressed out for ML purposes. ML models can be trained in any ML platform that supports GPUs (e.g., NVIDIA GPUs by NVIDIA of Santa Clara, CA, USA) with federated data (e.g., SAP data).

Users building machine learning models utilizing GPUs instead of CPUs will also realize an increase in efficiency due to reduce time consumed in training complex ML models (i.e., speeding up the ML model training cycle). As a result of the efficiency increase, users do not need to compromise on complexity of algorithms needed to build ML models. The efficiency increase helps reduce a total cost of ownership (TCO) and reduce extract, transform, load (ETL) process costs. Moreover, since data does not need to be extracted at table level, data semantics can be preserved and avoid a need to rebuild semantics by the user.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a box diagram of an example system for an SAP federated machine learning (FedML) solution, according to an implementation of the present disclosure.

FIG. 2A is a table illustrating a comparison of GPU acceleration for feature calculation and training between CPU and GPU code execution, according to an implementation of the present disclosure.

FIG. 2B is a table illustrating acceleration number recorded for GPU environments, according to an implementation of the present disclosure.

FIG. 3 is a flowchart illustrating an example of a computer-implemented method for machine learning (ML) with federated data in graphics processing units (GPUs) and direct artificial intelligence (AI) core deployment, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes machine learning with federated data in graphics processing units (GPUs) and direct artificial intelligence (AI) core deployment and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Data federation is a data integration technique permitting data from disparate sources to be presented in a unified view without requiring physical data movement or consolidation. A federated database is understood to refer to a database system where multiple autonomous databases are interconnected and managed as a single federated database. The federated approach permits users to access and retrieve data from multiple databases with a single query, even if the databases are heterogeneous and geographically decentralized.

Traditionally, using data (e.g., from SAP of Walldorf, Germany) with a machine-learning (ML) platform or AI service like GOOGLE VERTEX AI, MICROSOFT AZURE ML, AMAZON SAGEMAKER, or IBM WATSONX. AI on GPU computes requires egressing and persisting the data on a ML platform first, e.g. in GOOGLE CLOUD STORAGE or DATABRICKS DELTA LAKE. However, this persistence requirement creates a data duplication problem that leads to data inconsistencies and loss of data governance. Moreover, duplicated data needs to be transformed and read into GPU-supported data structures before it can be used for model training. This creates multi-step, inefficient, and error-prone ML processes.

Users building ML models utilizing central processing units (CPUs) see a decrease in efficiency due to time consumed in training complex ML models. Moreover, if SAP data is egressed out to train such models, it increases extract, transform, load (ETL) process costs, pushing total cost of ownership (TCO) of such projects to be much higher, proving it inefficient. In addition, data extracted at a database table level will result in loss of semantics, which will need to be rebuilt by the user.

Currently there is no existing solution that helps in procuring “real-time” SAP data (e.g., business or other data) directly from application sources for training ML models in a GPU environment. Currently it is also not possible to directly deploy GPU-trained ML models into SAP AI CORE functionality (which provides AI models permitting fine-tuning, deployment, and integration of AI into both SAP and non-SAP application solutions-an AI service) without going through a ML workflow process of the SAP AI CORE functionality while using the SAP BUSINESS TECHNOLOGY PLATFORM (BTP) environment.

Described is an approach providing an updated SAP federated machine learning (FedML) library architecture that supports GPU infrastructures. In some implementations, the FedML libraries are in PYTHON or other programming language. Data accessible in the SAP DATASPHERE warehouse-as-a-service (WaaS) (virtually or physically) can be directly used in GPU environments to train a ML model or for inference in a ML platform environment, without a need to persist the data first out of SAP systems. SAP DATASPHERE enables integration and a unified view of semantically rich data with third-party data across an enterprise landscape. GPU-trained ML models can also be directly deployed in SAP AI CORE functionality directly from GPU ML environments.

Prior to providing GPU support, the SAP FedML library architecture supported just CPUs. For ML models build in GPU computes, data needed to be egressed out of SAP systems (e.g., causing duplication and inconsistency issues) and then read back into GPUs. While the original architecture worked for simpler traditional models, it could not be used in GPUs as it did not support GPUs, nor could the ML models be deployed in SAP AI CORE functionality. With the described approach, not only can the SAP data be read directly into GPUs, but ML models trained on those GPUs can be seamlessly deployed into SAP AI CORE functionality directly from the GPU platform's ML environment. The approach simplifies complex ML model training and deployment on GPUs, bringing it closer to SAP systems and protecting SAP's data that was originally otherwise egressed out for ML purposes.

In other words, the enhanced SAP FedML library architecture applies data federation architecture of SAP DATASPHERE for intelligently sourcing SAP as well as non-SAP data for ML experiments performed at any ML platform, thereby removing a need for replicating or moving data. The SAP FedML library architecture includes GPU and SAP AI CORE support. By abstracting data connection and data load, the SAP FedML libraries provide end-to-end platform agnostic integration support for instant data access and discovery of semantically rich data with just few lines of code. ML models can be directly trained on a GPU with federated SAP data and the trained models directly deployed in SAP AI CORE.

### GPU Support in SAP FedML

Accelerated Workloads: SAP FedML now permits SAP data to be read directly into GPU compute unified device architecture (CUDA) data frames for machine learning workloads in GPU machines.

RAPIDS Framework support: SAP FedML now has integral support for RAPIDS Framework (i.e., an open-source suite of GPU-accelerated data science and AI libraries with application programming interfaces (APIs) that match popular open-source data tools) allowing access to GPU-accelerated machine learning algorithms with cuML (i.e., a suited of fast, GPU-accelerated ML algorithms for data science and analytical tasks).

AI model training made possible with federated SAP data: SAP FedML's support for GPUs helps with sourcing of semantically rich data directly from SAP systems and helps avoid time-consuming, inefficient, and costly extract, transform, load (ETL) processes and to speed up ML model training cycles. As a result of at least the efficiency increase, users do not need to compromise on complexity of algorithms needed to build ML models.

ML platform-agnostic: SAP FedML can be used in CPU or GPU machines regardless of the ML platforms, and has built-in CPU/GPU auto detection to take advantage of acceleration offered using CUDA data frame-supported training in, for example, NVIDIA GPUs (by NVIDIA of Santa Clara, CA, USA). SAP FedML can also be used on GPU virtual machines (VMs) offered by major platforms (e.g., AMAZON SAGEMAKER, GOOGLE VERTEX AI, and DATABRICKS.

### SAP AI CORE Deployment Support

ML Models that are trained in any ML Platform can now be deployed in a generative AI (GenAI) Hub of SAP AI CORE directly and without leaving the ML platform. Integrated support for SAP AI CORE helps data scientists to deploy even the GPU trained models as GPU deployments in SAP AI CORE.

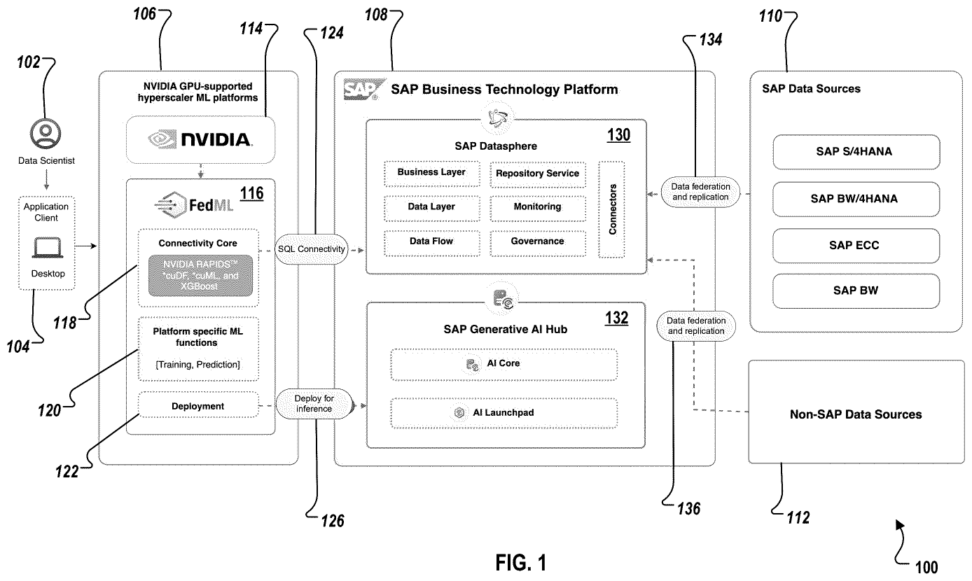

FIG. 1 is a box diagram of an example system 100 for a SAP FedML solution, according to an implementation of the present disclosure. As shown in FIG. 1 and at a high-level, system 100 includes a data scientist 102, application client 104, NVIDIA GPU-supported hyperscalar ML platforms 106, SAP BTP 108, SAP data sources 110 (e.g., SAP S/HANA, SAP BW/4HANA, SAP ECC, and SAP BW), and non-SAP data sources 112.

The NVIDIA GPU-supported hyperscalar ML platforms include NVIDIA GPU(s) 114 and SAP FedML library 116. The SAP FedML library 116 includes a connectivity core 118 (e.g., including NVIDIA RAPIDS, cuDF (PYTHON GPU DataFrame library), cuML (suite of libraries providing ML algorithms and mathematical primitives), and XGBoost (an advanced ML algorithm)), platform specific ML functions 120, and a deployment module 122. The connectivity core 118 includes and SAP DATASPHERE connection (e.g., a structured query language (SQL) connectivity 124), data exploration, and data retrieval feature support; out of the box support (e.g., using platform specific ML functions 120) for enabling reading of SAP data (e.g., 110) directly into cuDF; automatic detection of NVIDIA GPU(s) (e.g., 114); RAPIDS framework support for cuDF and cuML; and SAP AI CORE deployment support (e.g., using deployment 122) along illustrated flow 126 (deployment for inference) to both CPU and GPU endpoints. The model is being deployed for inferencing to the AI Core of the SAP Generative AI Hub 132. In some implementations and at a high-level, the AI Core is an AI model lifecycle management and orchestration layer. The AI Launchpad of the SAP Generative AI Hub 132 helps users easily manage AI use cases across multiple runtime instances.

The SAP BTP 108 includes the SAP DATASPHERE 130. Illustrated as included in the SAP DATASPHERE 130 is a business layer, repository service, data layer, monitoring functionality, data flow, governance functionality, and connectors (or a warehouse as a service solution). In some implementations and at a high-level, the business layer is a high-level abstraction layer on top of an underlying data layer (an actual data management layer) to permit modeling of data. A repository service is an implementation detail for managing data persistence. Monitoring functionality includes components that help track and monitor data and actions in the DSP. Data flow is a component or functionality that helps with data movement. Governance functionality is the feature that helps maintain data governance and security. Connections are underlying mechanisms that help connect disparate data sources to help with data unification.

The SAP BTP 108 also includes the SAP GENERATIVE AI HUB 132. The SAP GENERATIVE AI HUB 132 acts as a main hub for including generative AI tasks in SAP AI applications (e.g. SAP AI CORE and AI LAUNCHPAD illustrated within the SAP GENERATIVE AI HUB 132).

The SAP BTP 108's SAP DATASPHERE service 130 also includes a data federation and replication connectivity 134 with the SAP data sources 110. This interface permits access, exploration and replication of semantically rich SAP data sources 110. Similarly, a data federation and replication connectivity 136 permits access, exploration, and replication of non-SAP data sources 112.

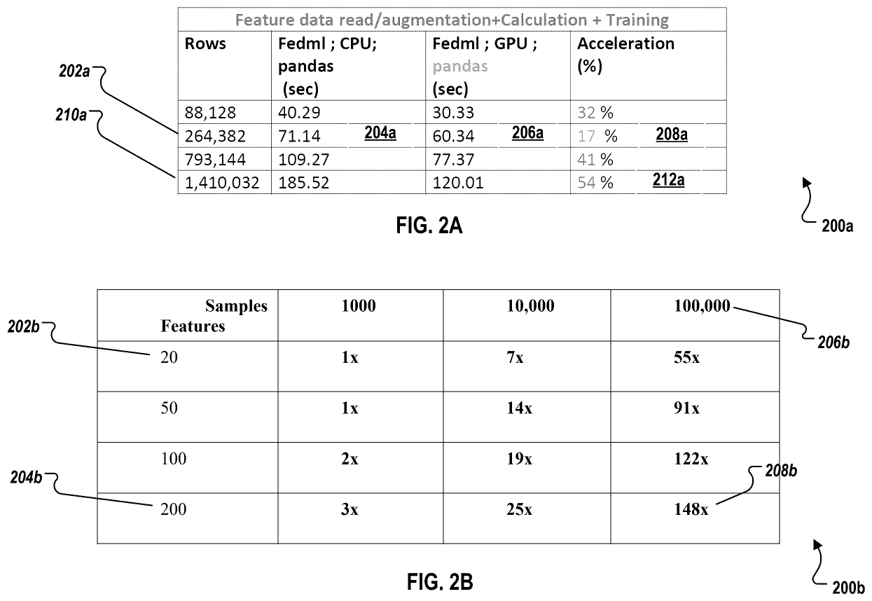

FIGS. 2A and 2B are tables illustrating comparisons of GPU acceleration for feature calculation and training. The processing illustrated in FIGS. 2A & 2B represent tree-based models commonly used and applied to problems including inventory forecasting, ad ranking, medical diagnostics, and scientific analysis.

For example, turning to FIG. 2A, FIG. 2A is a table 200a illustrating a comparison of GPU acceleration for feature calculation and training between CPU and GPU code execution, according to an implementation of the present disclosure. FIG. 2A illustrates feature data read/augmentation plus calculation and training for vertex-AI instance data in varying numbers of rows of 12 columns and using an cuML XgBoost algorithm. It can be seen that in all instances, acceleration increased (i.e., reduced time needed) between executing pandas code on a CPU vs. GPU. In one particular example using CPU(s), for number of rows 202a (264,382), the total time required 204a was 71.14 sec, while in comparison, the total time required 206a was 60.34 sec using GPU(s). This was an acceleration 208a of 17%. It should be pointed out that the acceleration increases given more rows. For example, number of rows 210a (1,410,032) had an acceleration 212a of 54%

Turning to FIG. 2B, FIG. 2B is a table 200b illustrating acceleration number recorded for GPU environments, according to an implementation of the present disclosure. In FIG. 2B, for the cuML XgBoost algorithm, comparing GPUs vs their CPU equivalents, the illustrated acceleration numbers were recorded for GPU environments with varying data loads and features. For number of features 202b (20), GPU acceleration increased (e.g., 1, 7×, and 55×) with an increasing number of samples (e.g., here 1000; 10,000; and 100,000), respectively. It should also be noted that as both the number of features and sample increase, the GPU acceleration also increases. For example, for number of features 204b (200) and samples 206b (100,000), GPU acceleration 208b was recorded at 148×.

In an implementation of the described approach, an example of an SAP FedML library for the described approach includes:
fedml
fedml currently supports the ability to deploy ml models to SAP AI CORE
FedML class
Prerequisites
To deploy a ML model to AI Core, you must have a docker image published somewhere (i.e. AWS ECR, dockerhub, Azure ACR, GCP Container Registry, etc.)
You must also already have AI Core enabled in your BTP account.
Installing the Library
pip install fedml
Importing the Library
from fedml import Fedml
Constructor
Fedml(ai_service_key)
Initializes the connection to AI Core.
Parameters:
ai_service_key (str): Your ai core service key JSON file relative to the notebook you are using the FedML Generic library in.

You can create an AI Core Service Key by following these steps (here) and (here)

Example of use:
fedml=Fedml(aic_service_key=‘aic_service_key. json’)
Deploying a Machine Learning Model to SAP AI CORE
Step 1:
First, you will need to onboard any ai core resources needed. These include your github repository, AI core resource group, and secret to provide AI core pull permissions to your docker registry.
onboard_ai_core(resource_group, github_info_path, create_resource_group=False, onboard_new_repo=False, secret_path=None)
Parameters:
Resource_group (str):
The AI Core resource group you are using. If you are creating this resource group, you must provide True to the create_resource_group parameter.
github_info_path (str):
A path to a JSON file containing the information needed for github access. Recall the importance of GitHub with SAP AI CORE by reviewing this documentation (here). You do not need to complete all of these steps. Only steps 1 and 2 are relevant for creating the Github PAT.
The format of this json file is as follows:

```
  {
    “name”: “<SAP AI CORE resource group>”,
    “url”: “<Github url>”,
    “username”: “<Github username>”,
    “password”: “<Github PAT. Follow the tutorial
    Steps 1 & 2 given above for
steps on how to create this>”
  }
```

create_resource_group (bool):
True if you want to create a resource group in SAP AI CORE. False if you do not (i.e., you are using an existing one).
onboard_new_repo (bool):
True if you want to onboard a new Github repo to SAP AI CORE. False if you do not (i.e., you are using an existing one).
secret_path (str):
The path where your docker registry secret file (JSON) is located relative to the notebook you are running this library in. This file should have the following structure:

```
  {
    “name”: “secretname”,
    “data”: {
      “.dockerconfigjson”: “{\“auths\”:{\“YOUR_DOCKER_REGISTRY_URL\”:
{\“username\”:\“YOUR_DOCKER_USERNAME\”,\“password\”:
\“YOUR_DOCKER_ACCESS_TOKEN\”}}}”
      }
  }
```

If you are using AWS, please follow (this) to generate the secret. If you are using GCP, please follow (this) to generate the secret. Other docker container registries are supported as well. Please find your container registries authorization information accordingly.

### Example of Use

fedml.onboard_ai_core(create_resource_group=False, resource_group=‘ai-core-test2’, onboard_new_repo=False, github_info_path=“github_info.json”, secret_path=“secret.json”)
Step 2:
Next, you need to register the application you want to use in AI Core. You only need to perform this step when you need to register a new application. So, if you are using an already existing AI Core application for your deployment, skip this step.
register_application(application_details)
Parameters:
application_details (dict):
The format of this dictionary is:

```
  {
    “application_name”: “<application name>”,
    “revision”: “<the commit (HEAD or a number for the revision commit to point
to) in github>”,
    “repository_url”: “<github url. NOT down to the path of the application. Just
the repo.>”,
    “path”: “<the folder for which the applications serving executable yaml is
located>”
  }
```

For information on how to create and structure a serving executable yaml, please refer to this (tutorial)
An example of the YAML is also shown here:

```
  apiVersion: ai.sap.com/v1alpha1
  kind: ServingTemplate
  metadata:
    name: <your chosen name>
    annotations:
      scenarios.ai.sap.com/description: “<a scenario description>”
      scenarios.ai.sap.com/name: “<your chosen scenario name>”
      executables.ai.sap.com/description: “<a description>”
      executables.ai.sap.com/name: “<your chosen executable name>”
    labels:
      scenarios.ai.sap.com/id: “<your chosen id>”
      ai.sap.com/version: “1.0.0”
  spec:
    inputs:
      artifacts:
```

| | |
|---|---|
| - | name: modelArtifact |

```
    template:
      apiVersion: “serving.kubeflow.org/v1beta1”
      metadata:
        labels: |
```

ai.sap.com/resourcePlan: infer.s

```
      spec: |
        predictor:
```

| imagePullSecrets: | |
|---|---|
| - | name: <secret for which you are using to authenticate to the container |

registry. this is the secret you onboarded earlier.>

| containers: | |
|---|---|
| - | name: kfserving-container |
| | image: “<image as given by your container registry>” #replace this |
| | ports: |

| | |
|---|---|
| - | containerPort: <port> |
| | protocol: TCP |

Note the repository_url here must already be onboarded with aicore. if not please use the onboard_ai_core( ) function to onboard it.

### Example of Use

Suppose your application details were as follows:

```
application_details =
{
  “application_name”: “application1”,
  “revision”: “HEAD”,
  “repository_url”: “https://github.com/username/repo_name”,
  “path”: “applicationyamlpath”
}
```

The path in the above dictionary should only be the path to the yaml folder.
You would then pass this dictionary to the function as so: fedml. register_application(application_details=application_details)
If the registration was successful, you should get a message stating that. Otherwise, the error should be shown to you.
Step 3:
Following, you can begin your deployment to AI Core.
ai_core_deploy(deployment_config)
Returns an endpoint.
Parameters:
deployment_config (dict):
The format of this dictionary is as follows:

```
{
  “name”: “<application name>”,
  “resource_group”: “<resource group name>”,
  “scenario_id”: “<scenario id>”,
  “executable_id”: “<executable id>”
}
```

name should be the name of the AI Core application you have been referencing throughout your code for deployment.
resource_group should be resource group you've been using for SAP AI CORE throughout this notebook
scenario_id should be the scenario_id in the serving executable yaml in the github workflow you created
   executable_id should be the executable_id in the serving executable yaml in the github workflow you created.

### Example of Use

```
deployment_config =
{
  “name”: “applicationname”,
  “resource_group”: “resourcegroupname”,
  “scenario_id”: “scenarioid”,
  “executable_id”: “executableid”
}
```

endpoint=fedml.ai_core_deploy(deployment_config=deployment_config).
Step 4:
Finally, after deployment is done, you can inference your model
ai_core_inference(endpoint, headers, body)
Returns an inference response.
Parameters:
endpoint(str): The api endpoint that was returned from the ai_core_deploy( . . . ) function. The api endpoint is also printed to the logs and can be found in AI Core Launchpad if needed to reference again.
headers(dict):
The headers needed for inferencing.

```
  {
    ″Authorization″: <Authorization token. Please refer to the
‘get_ai_core_token( )‘ function below>,
    ″ai-resource-group″: ″<ai core resource group>″,
    ″Content-Type″: ″<content type of data inferencing. this is specific to your
model you are deploying.>″
  }
  body(dict): The data to which you want to pass to your endpoint for predictions.
  get_ai_core_token( ) To get the authorization token needed to authorize
inferencing calls to SAP AI CORE.
```

### Example of Use

```
  endpoint = ‘https://endpoint.com’
  headers = {
    “Authorization”: fedml.get_ai_core_token( ),
    “ai-resource-group”: “aicoreresourcegroup”,
    “Content-Type”: “text/csv”}
  data = { }
  response_data =
fedml.ai_core_inference(endpoint=endpoint,headers=headers,body=X.to_json( )).
```

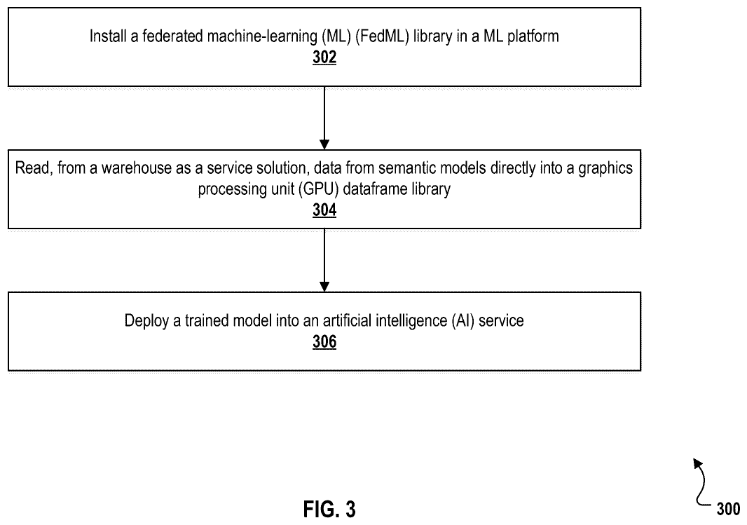

FIG. 3 is a flowchart illustrating an example of a computer-implemented method for machine learning with federated data in GPUs and direct AI core deployment, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, a federated machine-learning (ML) (FedML) library is installed in a ML platform. In some implementations, after installing the FedML library in a ML platform, a connection is made to the warehouse as a service solution. From 302, method 300 proceeds to 304.

At 304, data from semantic models is read from a warehouse as a service solution directly into a graphics processing unit (GPU) dataframe library. In some implementations, the warehouse as a service solution is SAP DATASPHERE and the GPU dataframe library is PYTHON cuDF. In some implementations, to generate a trained model, linear regression training is performed with the GPU dataframe library and a prediction is performed using the trained model. performing, using the trained model, a prediction. In some implementations, a docker container is built for the trained model. In some implementations, the AI service is SAP AI CORE, and deployment provides a reference to the docker container. From 304, method 300 proceeds to 306.

At 306, a trained model is deployed into an artificial intelligence (AI) service. In some implementations, deploying a trained model into an AI service includes: 1) onboarding needed AI service resources; 2) registering, in the AI service, a software application for use with the AI service; and 3) performing deployment of the software application for use to the AI service. After 304, method 300 can stop.

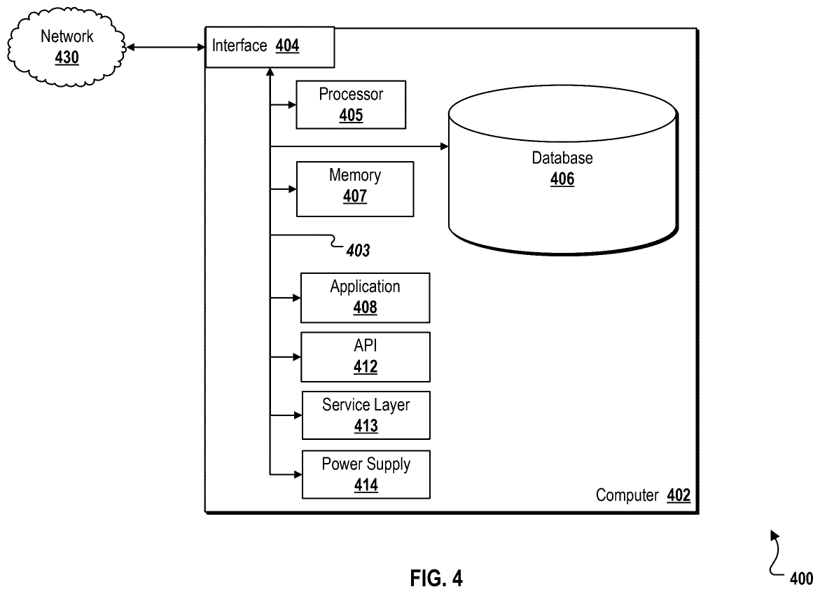

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, computer-implemented system 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or de-pendent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 402, alternative implementations can illustrate the API 412 or the Service Layer 413 as stand-alone components in re-lation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 406 that can hold data for the Computer 402, another component communicatively linked to the Network 430 (whether illustrated or not), or a combination of the Computer 402 and another component. For example, Database 406 can be an in-memory or conventional database storing data consistent with the present disclosure. In some implementations, Database 406 can be a combination of two or more different database types (for example, a hybrid in-memory and conventional database) according to particular needs, desires, or particular implementations of the Computer 402 and the described functionality. Although illustrated as a single Database 406, two or more databases of similar or differing types can be used according to particular needs, desires, or particular implementations of the Computer 402 and the described functionality. While Database 406 is illustrated as an integral component of the Computer 402, in alternative implementations, Database 406 can be external to the Computer 402. The Database 406 can hold and operate on at least any data type mentioned or any data type consistent with this disclosure.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user-or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features, alone or in combination.

For example, in a first implementation, a computer-implemented method, comprising: installing a federated machine-learning (ML) (FedML) library in a ML platform; reading, from a warehouse as a service solution, data from semantic models directly into a graphics processing unit (GPU) dataframe library; and deploying a trained model into an artificial intelligence (AI) service.

For example, in a second implementation, a non-transitory, computer-readable medium storing one or more instructions executable by a computer system to perform one or more operations, comprising: installing a federated machine-learning (ML) (FedML) library in a ML platform; reading, from a warehouse as a service solution, data from semantic models directly into a graphics processing unit (GPU) dataframe library; and deploying a trained model into an artificial intelligence (AI) service.

For example, in a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: installing a federated machine-learning (ML) (FedML) library in a ML platform; reading, from a warehouse as a service solution, data from semantic models directly into a graphics processing unit (GPU) dataframe library; and deploying a trained model into an artificial intelligence (AI) service.

The foregoing and other described implementations can each, optionally, include one or more of the following features:

A first feature, combinable with any of the following features, comprising: after installing a federated machine-learning (ML) (FedML) library in a ML platform, connecting to the warehouse as a service solution.

A second feature, combinable with any of the previous or following features, wherein the warehouse as a service solution is SAP DATASPHERE, and wherein the GPU dataframe library is PYTHON cuDF.

A third feature, combinable with any of the previous or following features, comprising: performing, to generate a trained model, linear regression training with the GPU dataframe library; and performing, using the trained model, a prediction.

A fourth feature, combinable with any of the previous or following features, comprising: building a docker container for the trained model.

A fifth feature, combinable with any of the previous or following features, wherein the AI service is SAP AI CORE, and wherein deployment provides a reference to the docker container.

A sixth feature, combinable with any of the previous features, wherein deploying a trained model into an artificial intelligence (AI) service, comprises: onboarding needed AI service resources; registering, in the AI service, a software application for use with the AI service; and performing deployment of the software application for use to the AI service.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU can receive instructions and data from and write to a memory. The essential elements of a computer are a CPU, for performing or executing instructions, and one or more memory devices for storing instructions and data. Generally, a computer can also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many particular implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some implementations, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations, steps, or actions are depicted in the drawings or claims in a particular order, this should not be understood as requiring that such operations, steps, or actions be performed in the particular order shown or in sequential order, or that all illustrated operations, steps, or actions be performed (some operations, steps, or actions can be considered optional), to achieve desirable results. In certain circumstances, multitasking or parallel processing (or a combination of multitasking and parallel processing) can be advantageous and performed as deemed appropriate.

The separation or integration of various components and/or system modules in the previously described implementations should not be understood as requiring such separation or integration in all implementations. In some implementations, described components and system modules can be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation may be applicable to a computer-implemented method; a non-transitory, computer-readable medium storing computer-readable instructions to perform the computer-implemented method; and/or a computer system comprising a computer memory interoperably coupled with a hardware processor configured to perform the computer-implemented method or the instructions stored on the non-transitory, computer-readable medium.

What is claimed is:

1. A computer-implemented method, comprising:
installing a federated machine-learning (ML) (FedML) library in a ML platform;
reading, from a warehouse as a service solution, data from semantic models directly into a graphics processing unit (GPU) dataframe library; and
deploying a trained model into an artificial intelligence (AI) service.

2. The computer-implemented method of claim 1, comprising:
after installing a federated machine-learning (ML) (FedML) library in a ML platform, connecting to the warehouse as a service solution.

3. The computer-implemented method of claim 1, wherein the warehouse as a service solution is SAP DATASPHERE, and wherein the GPU dataframe library is PYTHON cuDF.

4. The computer-implemented method of claim 1, comprising:
performing, to generate a trained model, linear regression training with the GPU dataframe library; and
performing, using the trained model, a prediction.

5. The computer-implemented method of claim 1, comprising:
building a docker container for the trained model.

6. The computer-implemented method of claim 5, wherein the AI service is SAP AI CORE, and wherein deployment provides a reference to the docker container.

7. The computer-implemented method of claim 1, wherein deploying a trained model into an artificial intelligence (AI) service, comprises:
onboarding needed AI service resources;
registering, in the AI service, a software application for use with the AI service; and
performing deployment of the software application for use to the AI service.

8. A non-transitory, computer-readable medium storing one or more instructions executable by a computer system to perform one or more operations, comprising:
installing a federated machine-learning (ML) (FedML) library in a ML platform;
reading, from a warehouse as a service solution, data from semantic models directly into a graphics processing unit (GPU) dataframe library; and
deploying a trained model into an artificial intelligence (AI) service.

9. The non-transitory, computer-readable medium of claim 8, comprising:
after installing a federated machine-learning (ML) (FedML) library in a ML platform, connecting to the warehouse as a service solution.

10. The non-transitory, computer-readable medium of claim 8, wherein the warehouse as a service solution is SAP DATASPHERE, and wherein the GPU dataframe library is PYTHON cuDF.

11. The non-transitory, computer-readable medium of claim 8, comprising:
performing, to generate a trained model, linear regression training with the GPU dataframe library; and
performing, using the trained model, a prediction.

12. The non-transitory, computer-readable medium of claim 8, comprising:
building a docker container for the trained model.

13. The non-transitory, computer-readable medium of claim 12, wherein the AI service is SAP AI CORE, and wherein deployment provides a reference to the docker container.

14. The non-transitory, computer-readable medium of claim 8, wherein deploying a trained model into an artificial intelligence (AI) service, comprises:
onboarding needed AI service resources;
registering, in the AI service, a software application for use with the AI service; and
performing deployment of the software application for use to the AI service.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
installing a federated machine-learning (ML) (FedML) library in a ML platform;
reading, from a warehouse as a service solution, data from semantic models directly into a graphics processing unit (GPU) dataframe library; and
deploying a trained model into an artificial intelligence (AI) service.

16. The computer-implemented system of claim 15, comprising:
after installing a federated machine-learning (ML) (FedML) library in a ML platform, connecting to the warehouse as a service solution.

17. The computer-implemented system of claim 15, wherein the warehouse as a service solution is SAP DATASPHERE, and wherein the GPU dataframe library is PYTHON cuDF.

18. The computer-implemented system of claim 15, comprising:
performing, to generate a trained model, linear regression training with the GPU dataframe library; and
performing, using the trained model, a prediction.

19. The computer-implemented system of claim 15, comprising:
building a docker container for the trained model.

20. The computer-implemented system of claim 15, wherein deploying a trained model into an artificial intelligence (AI) service, comprises:
onboarding needed AI service resources;
registering, in the AI service, a software application for use with the AI service; and performing deployment of the software application for use to the AI service.
